(19) United States
(12) Patent Application Publication
(10) Pub. No.: US 2026/0172805 A1
(43) Pub. Date: Jun. 18, 2026

(54) ONE-TIME NETWORK MONITORING EVENT DURATION MANAGEMENT

(71) Applicant: T-Mobile USA, Inc., Bellevue, WA (US)

(72) Inventors: Zenaida Castro Canlas-Factora, Renton, WA (US); Paul Marvin Lim Chy, Snohomish, WA (US)

(21) Appl. No.: 18/984,513

(22) Filed: Dec. 17, 2024

(51) Int. Cl. H04W 8/04; H04W 8/20; H04W 24/08

(52) U.S. Cl. CPC H04W 8/04; H04W 8/20; H04W 24/08

(57) ABSTRACT

A computer system implements one-time monitoring event subscriptions in mobile networks to address data consistency challenges between network elements. The system uses service capability exposure functions and network exposure functions to process monitoring event subscriptions from applications through standardized interfaces. A monitoringDuration parameter is added to configuration information request messages sent to a home subscriber server. The home subscriber server stores the duration value with the subscription and detects expired subscriptions even if delete messages fail. When the service capability exposure functions and network exposure functions receive an event notification from a mobility management entity, the functions initiates subscription deletion. If the home subscriber server misses a delete message, the home subscriber server can remove expired subscriptions based on the monitoring duration and notify the mobility management entity. Stale subscriptions are removed to maintain data consistency across network elements and reduce resource-intensive audits.

### BACKGROUND

Mobile networks use monitoring event systems to track and report network activities. Such monitoring event systems use service capability exposure functions and network exposure functions to enable applications to subscribe to and receive notifications about specific network events. A monitoring architecture can include multiple network elements such as home subscriber servers, mobility management entities, and application functions that work together to process and manage event subscriptions. Through Representational State Transfer-ful (RESTful) application programming interfaces defined by 3GPP specifications, the systems facilitate communication between network components and external applications, allowing for real-time monitoring of network events. However, traditional monitoring event systems are sometimes inadequate for maintaining data consistency across network elements and can require resource-intensive audit processes to ensure synchronization.

### BRIEF DESCRIPTION OF THE DRAWINGS

Detailed descriptions of implementations of the present technology will be described and explained through the use of the accompanying drawings.

FIG. 1 is a block diagram that illustrates an example wireless communications system that can implement aspects of the present technology.

FIG. 2 is a block diagram that illustrates an architecture including 5G core network functions that can implement aspects of the present technology.

FIG. 3 is a block diagram that illustrates an example system for one-time network monitoring event duration management.

FIG. 4 is a flowchart that illustrates an example process for one-time network monitoring event duration management.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Telecommunications networks use monitoring event systems that enable applications to track and receive notifications about specific network events through interfaces. Such monitoring event systems can use service capability exposure functions and network exposure functions to facilitate communication between applications and network elements, working alongside home subscriber servers and mobility management entities to process event subscriptions and notifications. Using Representational State Transfer-ful (RESTful) APIs defined by 3GPP specifications, the monitoring event systems enable real-time monitoring of network activities and event reporting. However, traditional implementations of one-time reporting subscriptions use the "maximumNumberOfReports = 1" parameter in 3GPP specifications, without incorporating monitoring duration parameters. Such implementations can be problematic when subscription removal messages fail between network elements, resulting in data inconsistency between service capability exposure functions / network exposure functions and home subscriber servers. To overcome such problems, telecommunication network operators may be required to implement resource-intensive audit processes to maintain synchronization across network elements, thereby creating operational inefficiencies.

This document describes methods, systems, and apparatuses that implement improved handling mechanisms for one-time monitoring event subscriptions using a "monitoringDuration" parameter. The methods and systems described herein can be applied to multiple monitoring event types such as loss of connectivity, user equipment (UE) reachability, roaming status, communication failures, packet data network (PDN) connectivity status, availability after defense data network (DDN) failure, application programming interface (API) support capability, and other event types. When an application function or service capability server initiates a one-time monitoring subscription request using the parameter maximumNumberOfReports = 1, the service capability exposure function / network exposure function enhances the request by adding the monitoringDuration parameter to the configuration information request message transmitted to the home subscriber server. The home subscriber server incorporates this duration value as an integral part of the dynamic monitoring subscription. Upon receiving a one-time reporting event notification from the mobility management entity, the service capability exposure function / network exposure function initiates a delete subscription message to the home subscriber server. Even if the delete message fails to reach the home subscriber server, the disclosed systems can maintain consistency using the monitoringDuration parameter, enabling the home subscriber server to independently detect and remove expired subscriptions.

In some implementations, a computer system manages one-time monitoring event subscriptions in a mobile network by receiving monitoring subscription requests from application functions. The requests specify one-time reporting using a maximum number of reports parameter. The requests are enhanced by adding a monitoring duration parameter to configuration information request messages sent to a home subscriber server, which stores this duration value as part of a dynamic subscription state. Upon receiving reporting notifications from a mobility management entity, the computer system initiates a multi-step deletion process that includes sending delete messages to the home subscriber server while enabling it to independently detect and remove expired subscriptions based on the monitoring duration parameter if delete messages fail. The disclosed implementations maintain data consistency across network elements without manual audits by allowing automatic cleanup of stale subscriptions through duration-based expiration tracking.

In some instances, a monitoring event subscription request is received from an application function through a standardized interface. A monitoring duration parameter can be added to a configuration information request message, which enables tracking of when subscriptions expire. The enhanced request is sent to a home subscriber server. When a monitoring event occurs, an event notification is received containing reporting information from a mobility management entity and the notification is sent to the original requesting application function. Subscription cleanup can be performed by initiating a deletion process in which a delete subscription message is sent to the home subscriber server based on receiving the event notification. Subscription lifecycle management is therefore while maintaining data consistency across network elements.

In some instances, monitoring event subscription management is performed in telecommunications networks with a focus on subscription lifecycle management. To enable tracking of subscription expiration, the system enhances a monitoring event subscription request by adding a monitoring duration parameter to the configuration information request message. The enhanced message, containing both the original request and the monitoring duration parameter, is sent to a home subscriber server. When a monitoring event occurs, an event notification containing reporting information is received from a mobility management entity and sent to the requesting application function. Subscription cleanup is performed by initiating a deletion process for the monitoring event subscription to improve resource management.

The benefits and advantages of the implementations described herein include improvements in network efficiency and reliability. The disclosed methods provide consistency between telecommunication network elements – service capability exposure function / network exposure function, home subscriber server, mobility management entity, and service capability server / application function – while reducing the need for time-consuming data audits. By automatically removing stale subscriptions and reducing unnecessary control plane messages, the disclosed methods improve resource utilization and enhance overall network performance. Moreover, audit efficiency is improved by reducing the need for time-consuming data synchronization checks between the service capability exposure function / network exposure function and home subscriber server. The automatic cleanup feature can remove stale subscriptions without manual intervention, while reducing unnecessary control plane messages when subscriptions are not properly deleted from the home subscriber server. Resource utilization is improved by maintaining only active subscriptions, enhancing overall network performance. Network reliability is improved by keeping monitoring activities synchronized and up-to-date. The comprehensive approach to subscription lifecycle management disclosed herein reduces operational overhead while maintaining network integrity.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

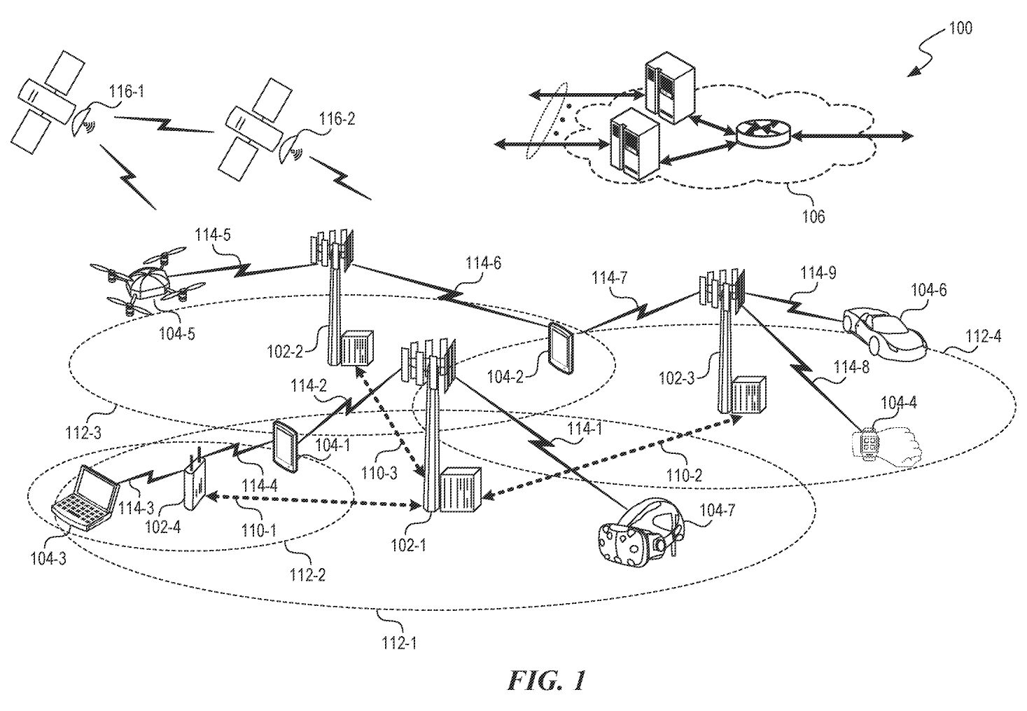

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNB is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the wireless telecommunications network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provides data to a remote server over a network; IoT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites such as satellites 116-1 and 116-2 to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service requirements and multi-terabits per second data transmission in the 6G and beyond era, such as terabit-per-second backhaul systems, ultrahigh-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low User Plane latency. In yet another example of 6G, the network 100 can implement a converged Wi-Fi and Core architecture to increase and improve indoor coverage.

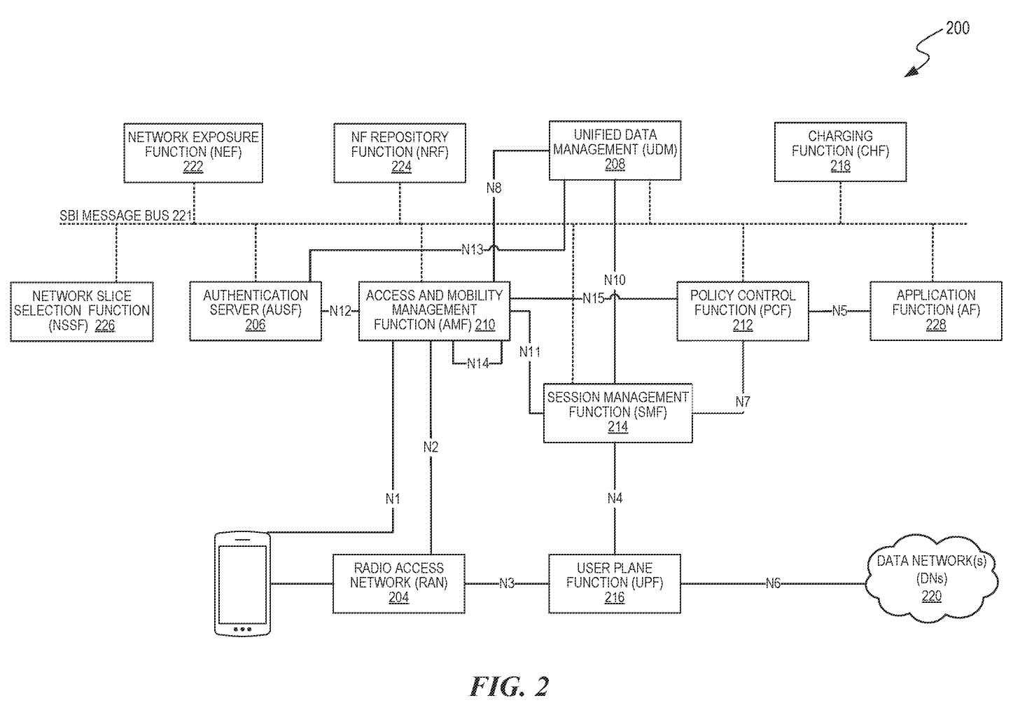

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, a NF Repository Function (NRF) 224 a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, service-level agreements, and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given the large number of wireless devices that can connect to a 5G network, the UDM 208 can contain voluminous amounts of data that is accessed for authentication. Thus, the UDM 208 is analogous to a home subscriber server, to provide authentication credentials while being employed by the AMF 210 and SMF 214 to retrieve subscriber data and context.

The PCF 212 can connect with one or more application functions (AFs) 228. The PCF 212 supports a unified policy framework within the 5G infrastructure for governing network behavior. The PCF 212 accesses the subscription information required to make policy decisions from the UDM 208, and provides the appropriate policy rules to the control plane functions so that they can enforce them. The SCP (not shown) provides a highly distributed multi-access edge compute cloud environment and a single point of entry for a cluster of network functions, once they have been successfully discovered by the NRF 224. This allows the SCP to become the delegated discovery point in a datacenter, offloading the NRF 224 from distributed service meshes that make-up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface, and the N11 interface between the AMF 210 and the SMF 214 assigned by the NRF 224, use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework which, along with the more typical QoS and charging rules, includes Network Slice selection, which is regulated by the NSSF 226.

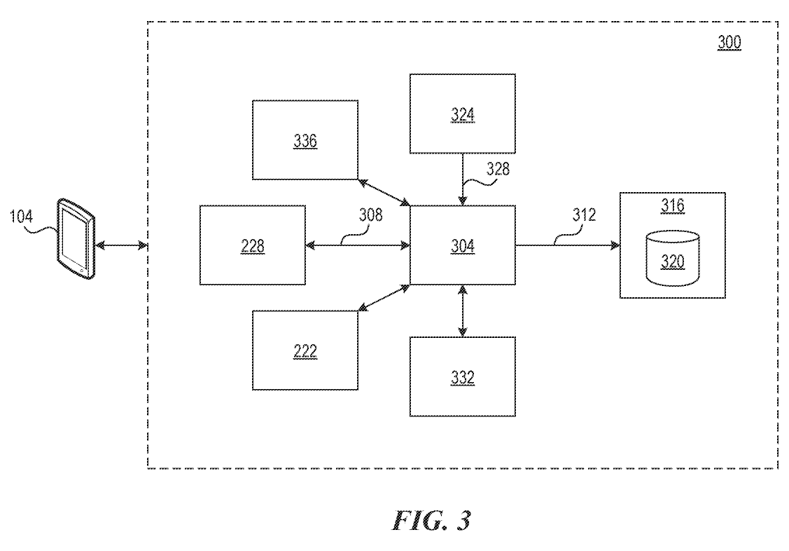

FIG. 3 is a block diagram that illustrates an example system for one-time network monitoring event duration management. The system includes a computer system 304, application function 228, network exposure function 222, mobility management entity 324, a home subscriber server 316 and a wireless device 104. The computer system 304, application function 228, network exposure function 222, mobility management entity 324, and home subscriber server 316 are part of a telecommunications network 300, which is the same as or similar to the network 100 illustrated and described in more detail with reference to FIG. 1. The application function 228, network exposure function 222 are illustrated and described in more detail with reference to FIG. 2. The wireless device 104 is illustrated and described in more detail with reference to FIG. 1. Likewise, embodiments of the system shown by FIG. 3 can include different and/or additional components or can be connected in different ways.

The computer system 304 implements methods and systems for managing one-time network monitoring event subscriptions in the telecommunications network 300. The architecture for managing monitoring event subscriptions shown by FIG. 3 includes several components and interfaces that communicate, including a service capability exposure function 332 / network exposure function 222 that communicates with the application function 228 using standardized northbound interfaces T8/N33. In some implementations, on the southbound side, the architecture includes two paths – a 5G path and a 4G/LTE path. In the 5G path, the network exposure function 222 connects to a user data management function (same as or similar to the UDM 208 shown by FIG. 2), which interfaces with an access and mobility management function (same as or similar to the AMF 210 shown by FIG. 2). For the 4G/LTE path, the service capability exposure function 332 connects to the home subscriber server 316, which can interface with the mobility management entity 324.

The computer system 304 integrates with different network protocols and standards using an architecture that supports both 5G and 4G/LTE implementations. The computer system 304 uses standardized message protocols including configuration information request, insert subscriber data request, and reporting information request messages to maintain consistent communication flows across network elements. Additionally, it implements service based architecture with service based interfaces that enable integration with various network functions including network repository function and network slice selection function, ensuring compatibility across different network implementations and standards.

The interfaces between the components shown by FIG. 3 are standardized according to 3GPP specifications. For example, the application function 228 communicates with the service capability exposure function 332 / network exposure function 222 through Representational State Transfer-ful (RESTful) application programming interfaces using the T8 or N33 interfaces. The service capability exposure function 332 / network exposure function 222 communicates with the home subscriber server 316 using configuration information request messages, while the home subscriber server 316 communicates with the mobility management entity 324 using insert subscriber data request messages.

For event reporting, the mobility management entity 324 sends notifications to the service capability exposure function 332 / network exposure function 222 using reporting information request messages when monitored events occur. The computer system 304 also implements service based architecture with service based interfaces that enable communication between various network functions including a network repository function, network slice selection function, and other core network components. The architecture shown by FIG. 3 provides improved handling of monitoring event subscriptions while maintaining data consistency across network elements through the monitoring duration parameter and standardized messaging protocols.

In some implementations, the computer system 304 receives monitoring event subscription requests 308 from an application function 228 through standardized interfaces such as T8 or N33. The interfaces enable applications to track and receive notifications about specific network events via the service capability exposure function 332 / network exposure function 222. For example, an application function may request to be notified about monitoring events (e.g., location changes or other network activities) of wireless device 104. When processing these requests, the computer system 304 enhances them by adding a monitoring duration parameter to configuration information request messages 312 sent to a home subscriber server 316. The enhancement addresses data consistency challenges between network elements that existed in traditional implementations which only used the maximumNumberOfReports parameter set to 1 for one-time reporting. The monitoring duration parameter serves as a safeguard mechanism that allows the home subscriber server 316 to independently detect and remove expired subscriptions, even if subsequent delete messages fail.

The computer system 304 sends the enhanced configuration information request message through standardized interfaces defined by 3GPP specifications to the home subscriber server 316. The home subscriber server 316, which acts as a central database for subscriber information and authentication credentials, stores this duration value in data store 320 as an integral part of the dynamic monitoring subscription. The storage capability is essential for maintaining proper subscription state management and enabling automated cleanup of expired subscriptions.

The computer system 304 can implement specific algorithms for detecting expired subscriptions through a multi-layered verification process. When the home subscriber server 316 receives a subscription with a monitoring duration parameter, it stores this timestamp in its data store and uses it as a reference point for expiration detection. The home subscriber server 316 continuously monitors active subscriptions by comparing the current time against each subscription's stored monitoring duration value. When a subscription's monitoring duration is reached, the home subscriber server’s internal logic automatically identifies it as expired, even without receiving explicit delete messages. This autonomous detection capability enables the home subscriber server 316 to independently maintain subscription state accuracy by removing expired entries from its database and triggering corresponding delete requests to the mobility management entity 324, ensuring proper cleanup across network elements without requiring manual intervention or complex synchronization processes.

In some examples, when a monitoring event (e.g., location change event) occurs, the computer system 304 system receives an event notification 328 containing reporting information from the mobility management entity 324. The mobility management entity 324 detects monitoring events from wireless devices 104 and sends notifications containing specific details such as tracking area identity information and/or current location retrieval status. The computer system 304 transmits these event notifications to the original requesting application function 228 through standardized interfaces.

The computer system 304 implements a comprehensive deletion process that includes multiple safeguards to maintain data consistency. For example, upon receiving an event notification, deletion is initiated by transmitting a delete subscription message to the home subscriber server 316. The home subscriber server 316 can independently detect expired subscriptions using the stored monitoring duration parameter, even when delete messages fail to reach it. This allows the home subscriber server 316 to automatically remove expired subscriptions from its data store 320 and transmit corresponding delete requests to the mobility management entity 324.

The telecommunications network 300 in which the computer system 304 operates includes multiple network elements working together to process and manage event subscriptions. For example, base stations 102 (shown by FIG. 1) provide wireless coverage to wireless devices 104 across geographic coverage areas 112. The core network 106 manages security services, user authentication, access authorization, tracking, IP connectivity and other network functions. The network 300 can implement various wireless technologies including 5G, LTE/LTE-A, and support different service environments like IoT, mobile broadband, V2X communications, and machine-type communications.

The system's architecture includes 5G core network functions that work together to enable the monitoring event subscription management. The network exposure function 222 exposes network capabilities through a service based architecture using service based interfaces. A user data management function can store subscriber information in a user data repository, while an access and mobility management function handles connection and mobility management. The network functions described herein communicate through standardized interfaces N1 through N15 as defined in relevant standards.

The mobility management entity 324 monitors wireless device 104 for monitoring events such as location changes and other specified events, generating notifications that contain detailed information about the events. These notifications are sent to the service capability exposure function 332 / network exposure function 222 for processing and forwarding to the appropriate application function 228. The home subscriber server 316 maintains the central database of subscriber information and manages the dynamic monitoring subscriptions. The home subscriber server 316 stores the monitoring duration parameter along with other subscription details in its data store 320, enabling independent tracking of subscription expiration. When subscriptions expire based on the monitoring duration, the home subscriber server 316 can automatically remove them and notify the mobility management entity 324, maintaining data consistency across the network 300.

The sequence of messages for processing a monitoring event subscription involves several key interactions between network elements. The application function 228 sends a monitoring event subscription request to the service capability exposure function 332 / network exposure function 222 through standardized northbound interfaces T8/N33. This initial request includes parameters such as maximumNumberOfReports = 1 to indicate one-time reporting requirements. Upon receiving this request, the service capability exposure function 332 / network exposure function 222 enhances it by adding the critical monitoring duration parameter to the configuration information request message before transmission to the home subscriber server 316.

The home subscriber server 316 processes the enhanced configuration information request by storing the monitoring duration parameter and communicates with the mobility management entity 324 through an insert subscriber data request message to establish the monitoring subscription. The mobility management entity 324 confirms the setup by responding to the home subscriber server 316 with an insert subscriber data answer message. The home subscriber server 316 sends a configuration information answer back to the service capability exposure function 332 / network exposure function 222, which notifies the application function 228 of successful subscription establishment.

When a monitored event occurs, such as a location change, the mobility management entity 324 detects it and sends a reporting information request message to the service capability exposure function 332 / network exposure function 222 containing the relevant event details. The service capability exposure function 332 / network exposure function 222 forwards this notification to the requesting application function 228 through the established interfaces.

The deletion process initiates after the event notification, with the service capability exposure function 332 / network exposure function 222 sending delete subscription messages to both the application function 228 and home subscriber server 316. Even if the delete message fails to reach the home subscriber server 316, the stored monitoring duration parameter enables the home subscriber server 316 to independently detect and remove expired subscriptions. The home subscriber server 316 can automatically send delete requests to the mobility management entity 324, ensuring proper cleanup of subscriptions across all network elements.

The automatic cleanup process involves multiple coordinated steps across network elements to ensure proper subscription removal. When a subscription's monitoring duration is reached, the home subscriber server 316 automatically detects the expired state through its internal verification logic and initiates the cleanup sequence. The home subscriber server 316 removes the expired subscription from its data store and transmits a delete request message to the mobility management entity 324 to ensure synchronization. Simultaneously, the service capability exposure function 332 / network exposure function 222 maintains its own cleanup process by verifying subscription status and removing expired entries from its database. If the delete message between network elements fails, the monitoring duration parameter serves as a backup mechanism, allowing each component to independently detect and remove expired subscriptions without requiring manual intervention or complex reconciliation procedures. This multi-layered approach ensures proper resource cleanup while maintaining data consistency across all network elements involved in the subscription lifecycle.

The comprehensive message sequence disclosed herein provides improved subscription management while maintaining data consistency through the monitoring duration parameter safeguard. The standardized interfaces and protocols defined by 3GPP specifications facilitate reliable communication between all network elements throughout the subscription lifecycle. The computer system 304 supports various types of wireless devices 104 including smartphones, tablets, laptops, wearables, drones, vehicles with wireless connectivity, and IoT devices. These devices 104 can communicate with different types of base stations and network equipment at the edge of the network 300. The network 300 supports multiple radio technologies and can handle various service environments with different quality of service requirements. The implementations improve network efficiency and reliability through automated subscription management. By maintaining consistency between network elements and reducing the need for manual audits, the computer system 304 reduces operational overhead. The automatic cleanup of expired subscriptions improves resource utilization and prevents issues caused by stale subscriptions. The comprehensive approach to subscription lifecycle management disclosed herein ensures handling of one-time monitoring events while maintaining network integrity.

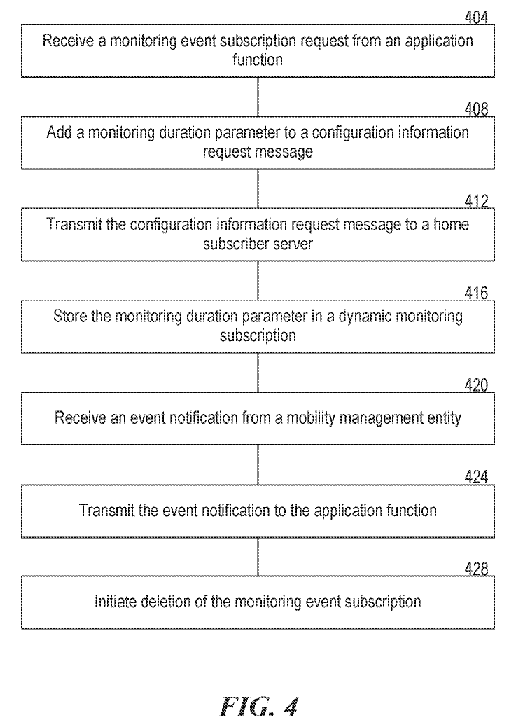

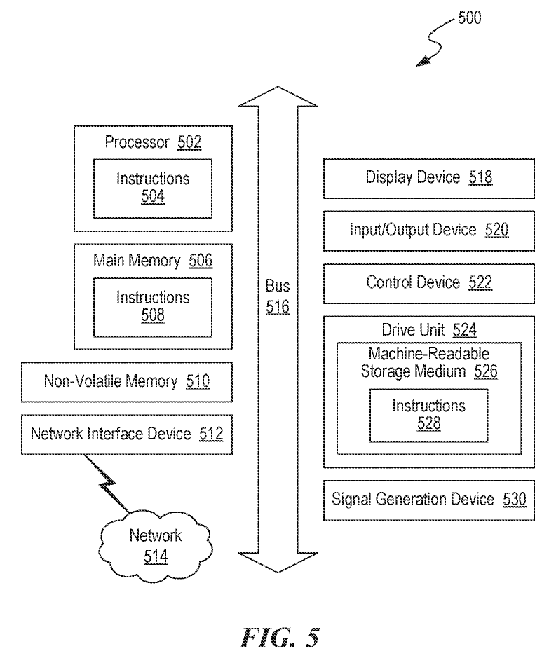

FIG. 4 is a flowchart that illustrates an example process for one-time network monitoring event duration management. In some implementations, the process is performed by the computer system 304 illustrated and described in more detail with reference to FIG. 3. In some implementations, the process is performed by example computer system 500 illustrated and described in more detail with reference to FIG. 5. Likewise, implementations can include different and/or additional steps or can perform the steps in different orders.

At 404, a computer system receives a subscription request from an application function in a telecommunications network. The application function and telecommunications network are the same as or similar to the AF 228 and the network 100 described in more detail with reference to FIGS. 1-2. The request is received via a standardized interface such as T8 or N33 and enables applications to track and receive notifications about specific network events through service capability exposure functions and network exposure functions. An example service capability exposure function 332 is described in more detail with reference to FIG. 3. The network exposure function is the same as or similar to the 222 described in more detail with reference to FIG. 2. For example, an application function may request to be notified about a user equipment’s location changes or other network activities. The user equipment is the same as or similar to the wireless devices 104-1 through 104-7 illustrated and described in more detail with reference to FIG. 1. The subscription request typically includes parameters such as maximumNumberOfReports set to 1 for one-time reporting scenarios.

At 408, the computer system adds a monitoring duration parameter to a configuration information request message. When the application function sends a one-time monitoring subscription request having the parameter maximumNumberOfReports = 1, the computer system enhances the request by adding the monitoring duration parameter before transmission. The addition enables the computer system to track when subscriptions expire and maintain proper subscription lifecycle management. The monitoring duration parameter serves as a safeguard mechanism that allows a home subscriber server to independently detect and remove expired subscriptions, even if subsequent delete messages fail to reach it. An example home subscriber server 316 is described in more detail with reference to FIG. 3.

At 412, the computer system sends the enhanced configuration information request message, which now includes both the original subscription request parameters and the added monitoring duration parameter, to the home subscriber server. The home subscriber server serves as a central database for subscriber information and authentication credentials in the network. The transmission step enables the home subscriber server to receive and process the monitoring duration parameter as part of the dynamic monitoring event subscription. The transmission occurs through standardized interfaces and protocols defined by 3GPP specifications, ensuring proper communication between the network exposure functions and the home subscriber server.

At 416, the computer system causes the home subscriber server to store the monitoring duration parameter as an integral part of the dynamic monitoring subscription to maintain the subscription state. The home subscriber server accepts and stores the duration value specified in the configuration information request message as part of the dynamic monitoring event subscription data. This storage capability (e.g., of data store 320 shown by FIG. 3) is useful for subscription state management since the home subscriber server acts as a central database for subscriber information and can use the stored duration parameter to independently detect and remove expired subscriptions. The storage of this parameter enables the home subscriber server to maintain proper subscription lifecycle management even if subsequent delete messages fail to reach it.

At 420, the computer system receives an event notification containing reporting information from a mobility management entity when a monitoring event is triggered in the network. An example mobility management entity 324 is shown by FIG. 3. For example, when a user equipment triggers a monitoring change event, the mobility management entity detects the event and sends a notification containing specific details such as tracking area identity information and current location retrieval status to the network exposure function. The notification is transmitted through standardized interfaces and protocols, with the mobility management entity using reporting information request messages to communicate the reporting information to the service capability exposure function / network exposure function. The event notification serves as confirmation that the monitored event has occurred and contains the relevant data requested in the original subscription.

At 424, the computer system sends the received event notification containing reporting information to the requesting application function. After receiving the notification from the mobility management entity, the service capability exposure function / network exposure function forwards this information to the application function through standardized interfaces such as T8/N33. The notification includes specific details such as the monitoring type, location reporting information, tracking area identity, and/or current location retrieval status that was originally requested in the subscription.

The computer system implements comprehensive error handling procedures for failed message delivery through multiple safeguard mechanisms. When a delete subscription message fails to reach the home subscriber server from the service capability exposure function / network exposure function, the monitoring duration parameter serves as a critical backup mechanism that enables the home subscriber server to independently detect and handle the expired subscription. The home subscriber server maintains its own internal logic to verify subscription expiration based on the stored monitoring duration value, allowing it to automatically remove expired subscriptions from its database and transmit corresponding delete requests to the mobility management entity even when communication failures occur. This autonomous error handling capability ensures proper subscription cleanup and maintains data consistency across network elements without requiring manual intervention or complex reconciliation procedures, effectively preventing issues where stale subscriptions remain active due to failed message delivery.

At 428, the computer system performs a comprehensive deletion process for monitoring event subscriptions that includes multiple safeguards. After receiving the event notification, the computer system initiates deletion by transmitting a delete subscription message to the home subscriber server. The computer system enables a safeguard mechanism where the home subscriber server can independently detect expired subscriptions using the stored monitoring duration parameter, even if the delete message fails to reach it. This independent detection capability allows the home subscriber server to automatically remove expired subscriptions from its database and transmit corresponding delete requests to the mobility management entity. The multi-layered approach disclosed herein provides subscription cleanup and maintains data consistency across network elements even when communication failures occur between components.

### Computer System

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, video display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computer system 500 can share a similar architecture as that of a server computer, personal computer (PC), tablet computer, mobile telephone, game console, music player, wearable electronic device, network-connected ("smart") device (e.g., a television or home assistant device), AR/VR systems (e.g., head-mounted display), or any electronic device capable of executing a set of instructions that specify action(s) to be taken by the computer system 500. In some implementation, the computer system 500 can be an embedded computer system, a system-on-chip (SOC), a single-board computer system (SBC) or a distributed system such as a mesh of computer systems or include one or more cloud components in one or more networks. Where appropriate, one or more computer systems 500 can perform operations in real-time, near real-time, or in batch mode.

The network interface device 512 enables the computer system 500 to mediate data in a network 514 with an entity that is external to the computer system 500 through any communication protocol supported by the computer system 500 and the external entity. Examples of the network interface device 512 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computer system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as "computer programs"). The computer programs typically comprise one or more instructions (e.g., instructions 504, 508, 528) set at various times in various memory and storage devices in computing device(s). When read and executed by the processor 502, the instruction(s) cause the computer system 500 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the examples, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following examples should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the examples. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

We Claim:

1. A computer system comprising:
at least one hardware processor; and
at least one non-transitory memory storing instructions, which, when executed by the at least one hardware processor, cause the computer system to:
receive a monitoring event subscription request from an application function of a telecommunications network;
add a monitoring duration parameter to a configuration information request message to enable tracking of subscription expiration;
transmit the configuration information request message including the monitoring duration parameter to a home subscriber server;
store, via the home subscriber server, the monitoring duration parameter in a dynamic monitoring subscription for maintaining a subscription state;
receive an event notification comprising reporting information from a mobility management entity;
transmit the event notification to the application function; and
initiate deletion of the monitoring event subscription by performing steps to:
transmit a delete subscription message to the home subscriber server based on the event notification;
enable the home subscriber server to detect an expired subscription based on the monitoring duration parameter when the delete subscription message fails to reach the home subscriber server; and
enable the home subscriber server to automatically remove the expired subscription and transmit a delete request to the mobility management entity.

2. The computer system of claim 1, wherein the monitoring event subscription request is received via at least one of a T8 interface or an N33 interface.

3. The computer system of claim 1, wherein the monitoring event subscription request includes a maximum number of reports parameter for one-time reporting.

4. The computer system of claim 1, wherein the computer system is caused to:
maintain data consistency between network elements including a network exposure function, the home subscriber server, and the mobility management entity in absence of manual audits.

5. The computer system of claim 1, wherein the computer system is caused to:
implement at least one of a service capability exposure function or a network exposure function.

6. The computer system of claim 1, wherein the reporting information is received in response to a user equipment triggering a location change event in the telecommunications network.

7. The computer system of claim 1, wherein the reporting information includes at least one of tracking area identity information or current location retrieval status.

8. At least one non-transitory computer-readable storage medium storing instructions, which, when executed by at least one data processor of a computer system, cause the computer system to:
receive a monitoring event subscription request from an application function of a telecommunications network;
add a monitoring duration parameter to a configuration information request message to enable tracking of subscription expiration;
transmit the configuration information request message including the monitoring duration parameter to a home subscriber server;
store, via the home subscriber server, the monitoring duration parameter in a dynamic monitoring subscription for maintaining a subscription state;
receive an event notification comprising reporting information from a mobility management entity;
transmit the event notification to the application function; and
initiate deletion of the monitoring event subscription by performing steps to:
transmit a delete subscription message for an expired subscription to the home subscriber server based on the event notification.

9. The non-transitory computer-readable storage medium of claim 8, wherein the computer system is caused to:
enable the home subscriber server to automatically remove the expired subscription and transmit a delete request to the mobility management entity.

10. The non-transitory computer-readable storage medium of claim 8, wherein the computer system is caused to:
enable the home subscriber server to detect the expired subscription based on the monitoring duration parameter when the delete subscription message fails to reach the home subscriber server.

11. The non-transitory computer-readable storage medium of claim 8, wherein the computer system is caused to:
maintain data consistency between network elements including a network exposure function, the home subscriber server, and the mobility management entity in absence of manual audits.

12. The non-transitory computer-readable storage medium of claim 8, wherein the computer system is caused to:
implement at least one of a service capability exposure function or a network exposure function.

13. The non-transitory computer-readable storage medium of claim 8, wherein the reporting information is received in response to a user equipment triggering a location change event in the telecommunications network.

14. The non-transitory computer-readable storage medium of claim 8, wherein the reporting information includes at least one of tracking area identity information or current location retrieval status.

15. A method performed by a computer system, comprising:
receiving a monitoring event subscription request from an application function of a telecommunications network;
adding a monitoring duration parameter to a configuration information request message to enable tracking of subscription expiration;
transmitting the configuration information request message including the monitoring duration parameter to a home subscriber server;
storing, via the home subscriber server, the monitoring duration parameter in a dynamic monitoring subscription for maintaining a subscription state;
receiving an event notification comprising reporting information from a mobility management entity;
transmitting the event notification to the application function; and
initiating deletion of the monitoring event subscription.

16. The method of claim 15, wherein initiating deletion of the monitoring event subscription includes:
transmitting a delete subscription message to the home subscriber server based on the event notification.

17. The method of claim 15, wherein initiating deletion of the monitoring event subscription includes:
enabling the home subscriber server to detect an expired subscription based on the monitoring duration parameter when the delete subscription message fails to reach the home subscriber server.

18. The method of claim 15, wherein initiating deletion of the monitoring event subscription includes:
enabling the home subscriber server to automatically remove the expired subscription and transmit a delete request to the mobility management entity.

19. The method of claim 15, comprising:
maintaining data consistency between network elements including a network exposure function, the home subscriber server, and the mobility management entity in absence of manual audits.

20. The method of claim 15, comprising:
implementing at least one of a service capability exposure function or a network exposure function.
